(19) United States
(12) Patent Application Publication
(10) Pub. No.: US 2025/0129866 A1
(43) Pub. Date: Apr. 24, 2025

(54) HANDHELD TOOL FOR OPENING AND CLOSING OUTSIDE STEM AND YOKE GATE VALVES

(71) Applicant: Daniel Dean, Peabody, MA (US)

(72) Inventor: Daniel Dean, Peabody, MA (US)

(21) Appl. No.: 18/382,790

(22) Filed: Oct. 23, 2023

(51) Int. Cl. F16K 31/60; A62C 35/68; B25B 13/50

(52) U.S. Cl. CPC F16K 31/60; A62C 35/68; B25B 13/50

(57) ABSTRACT

A handheld tool for opening and closing OS&Y gate valves commonly used to control water flow to fire sprinkler systems. The tool includes an elongated shape with curved central portion with two handles on either end. The tool contains a series of protrusions for engaging and rotating the spokes on the OS&Y gate valve handwheel.

### FIELD OF THE INVENTION

This invention relates to a handheld tool for opening and closing outside stem and yoke valves.

### BACKGROUND OF INVENTION

Many industries, including commercial building fire suppression systems, incorporate large outside stem and yoke gate valves (also known as “outside screw and yoke” or “OS&Y”) to control fluid flow, usually water, on pipelines or tanks. On an OS&Y gate valve, the valve gate is attached to a threaded stem with a handwheel that connects to the yoke element. The handwheel includes a hub secured to the valve stem, a circular outer handle, and spokes extending radially from the hub to the circular handle. OS&Y gate valves operate by opening and closing via a gate, which lowers into or rises out of the valve. A user grips the circular handle and rotates it to open or close the valve. Raising the gate allows fluid, such as water, to flow through the valve while lowering the gate cuts off the water flowing through the valve.

These OS&Y gate valves may be extremely difficult to turn due to non-use, age, internal valve pressure, corrosion, high temperatures, or their large size wheels. Failure to quickly turn the OS&Y gate valves may prevent the operation of critical systems, including delivering water to fire suppression systems in commercial buildings. In addition, attempting to turn old, large, and stuck OS&Y gate valves may result in injury or breakage to the handwheel. A user's attempts to force an OS&Y gate valve open may cause burns, blisters, and other injuries.

The invention of this application, an improved portable, lightweight tool for opening and closing OS&Y gate valves that need additional leverage to operate due to non-use, age, internal valve pressure, corrosion, high temperatures, or their large size wheels, while significantly reducing the effort required.

### SUMMARY OF THE INVENTION

There are additional features of the invention that will be described hereinafter, and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The subject invention discloses a handheld tool for opening and closing OS&Y gate valves for controlling water flow to fire sprinkler systems, the tool comprising: an elongated shape with a first end and a second end, wherein the first end and the second end form a first handle and a second handle, respectively; a central curved portion for engaging a central hub on a handwheel of the OS&Y gate valve; a plurality of protrusions configured to engage one or more spokes on the handwheel; wherein an operator places the central curved portion around the central hub of the handwheel and the plurality of protrusions about one or more spokes of the handwheel for engagement; further wherein the operator turns the elongated shape of the tool by the first handle and the second handle in a counterclockwise direction to open the OS&Y gate valve, wherein the plurality of protrusions simultaneously apply counterclockwise force to one or more spokes of the handwheel; further wherein the operator turns the elongated shape of the tool by the first handle and the second handle in a clockwise direction to close the OS&Y gate valve; wherein the plurality of protrusions simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the OS&Y gate valve; a plurality of protrusions, each protruding in a direction substantially perpendicular with the first plane of the long axis, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction to open the OS&Y gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the OS&Y gate valve; wherein the plurality of protrusions simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the OS&Y gate valve; a plurality of protrusions, each protruding in a direction substantially perpendicular with the first plane of the long axis and substantially perpendicular with the central curved portion, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction to open the OS&Y gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the OS&Y gate valve; wherein the plurality of protrusions simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the OS&Y gate valve; a plurality of protrusions, each protruding in a direction substantially perpendicular with the first plane of the long axis, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction that is substantially perpendicular with the first plane of the long axis to open the OS&Y gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the OS&Y gate valve; wherein the plurality of protrusions simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the OS&Y gate valve; a plurality of protrusions, each protruding in a direction substantially perpendicular with the first plane of the long axis and substantially perpendicular with the central curved portion, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction that is substantially perpendicular with the first plane of the long axis to open the OS&Y gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the OS&Y gate valve; wherein the plurality of protrusions simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the OS&Y gate valve; a plurality of protrusions, each protruding in a direction substantially perpendicular with the first plane of the long axis, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction that is substantially perpendicular with the first plane of the long axis and the direction of the plurality of protrusions, to open the OS&Y gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of protrusions, to close the OS&Y gate valve; wherein the plurality of protrusions simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the OS&Y gate valve; a plurality of protrusions, each protruding in a direction substantially perpendicular with the first plane of the long axis and substantially perpendicular with the central curved portion, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction that is substantially perpendicular with the first plane of the long axis and the direction of the plurality of protrusions, to open the OS&Y gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of protrusions, to close the OS&Y gate valve; wherein the plurality of protrusions simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion curving in a direction substantially parallel with the first plane of the long axis, a plurality of protrusions, each protruding in a direction substantially perpendicular with the first plane of the long axis, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction to open the OS&Y gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the OS&Y gate valve; wherein the plurality of protrusions simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis, a plurality of protrusions, each protruding in a direction substantially perpendicular with the first plane of the long axis and substantially perpendicular with the central arcuate portion, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction to open the OS&Y gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the OS&Y gate valve; wherein the plurality of protrusions simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central arcuate portion curving in a direction substantially parallel with the first plane of the long axis, a plurality of protrusions, each protruding in a direction substantially perpendicular with the first plane of the long axis, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction that is substantially perpendicular with the first plane of the long axis to open the OS&Y gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the OS&Y gate valve; wherein the plurality of protrusions simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis, a plurality of protrusions, each protruding in a direction substantially perpendicular with the first plurality of protrusions configured to grip one or more interior surfaces of radial around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction that is substantially perpendicular with the first plane of the long axis to open the OS&Y gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the OS&Y gate valve; wherein the plurality of protrusions simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion curving in a direction substantially parallel with the first plane of the long axis, a plurality of protrusions, each protruding in a direction substantially perpendicular with the first plane of the long axis, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise the direction of the plurality of protrusions, to open the OS&Y gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of protrusions, to close the OS&Y gate valve; wherein the plurality of protrusions simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis, a plurality of protrusions, each protruding in a direction substantially perpendicular with the first plane of the long axis and substantially perpendicular with the central arcuate portion, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction that is substantially perpendicular with the first plane of the long axis and the direction of the plurality of protrusions, to open the OS&Y gate valve, wherein the plurality of protrusions simultaneously apply counterclockwise force to one or more spokes of the handwheel; further wherein the operator turns the elongated shape of the tool by gripping and moving the first handle and the second handle in a clockwise the direction of the plurality of protrusions, to close the OS&Y gate valve; wherein the plurality of protrusions simultaneously apply clockwise force to one or more spokes of the handwheel.

The subject invention discloses a handheld tool for opening and closing outside stem and yoke gate valves for controlling water flow to fire sprinkler systems, the tool comprising: an elongated shape with a first end and a second end, wherein the first end and the second end form a first handle and a second handle, respectively; a central curved portion for engaging a central hub on a handwheel of the Outside stem and yoke gate valve; a plurality of protrusions configured to engage one or more spokes on the handwheel; wherein an operator places the central curved portion around the central hub of the handwheel and the plurality of protrusions about one or more spokes of the handwheel for engagement; further wherein the operator turns the elongated shape of the tool by the first handle and the second handle in a counterclockwise direction to open the Outside stem and yoke gate valve, wherein the plurality of protrusions simultaneously apply counterclockwise force to one or more spokes of the handwheel; further wherein the operator turns the elongated shape of the tool by the first handle and the second handle in a clockwise direction to close the Outside stem and yoke gate valve; wherein the plurality of protrusions simultaneously apply clockwise force to one or more spokes of the handwheel.

The subject invention discloses a handheld tool for opening and closing outside stem and yoke gate valves for controlling water flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the Outside stem and yoke gate valve; a plurality of protrusions, each protruding in a direction substantially perpendicular with the first plane of the long axis, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction to open the Outside stem and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the Outside stem and yoke gate valve; wherein the plurality of protrusions simultaneously apply clockwise force to one or more spokes of the handwheel.

The subject invention discloses a handheld tool for opening and closing outside stem and yoke gate valves for controlling water flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the Outside stem and yoke gate valve; a plurality of protrusions, each protruding in a direction substantially perpendicular with the first plane of the long axis and substantially perpendicular with the central curved portion, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction to open the Outside stem and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the Outside stem and yoke gate valve; wherein the plurality of protrusions simultaneously apply clockwise force to one or more spokes of the handwheel.

The subject invention discloses a handheld tool for opening and closing outside stem and yoke gate valves for controlling water flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the Outside stem and yoke gate valve; a plurality of protrusions, each protruding in a direction substantially perpendicular with the first plane of the long axis, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction that is substantially perpendicular with the first plane of the long axis to open the Outside stem and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the Outside stem and yoke gate valve; wherein the plurality of protrusions simultaneously apply clockwise force to one or more spokes of the handwheel.

The subject invention discloses a handheld tool for opening and closing outside stem and yoke gate valves for controlling water flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the Outside stem and yoke gate valve; a plurality of protrusions, each protruding in a direction substantially perpendicular with the first plane of the long axis and substantially perpendicular with the central curved portion, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction that is substantially perpendicular with the first plane of the long axis to open the Outside stem and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the Outside stem and yoke gate valve; wherein the plurality of protrusions simultaneously apply clockwise force to one or more spokes of the handwheel.

The subject invention discloses a handheld tool for opening and closing outside stem and yoke gate valves for controlling water flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the Outside stem and yoke gate valve; a plurality of protrusions, each protruding in a direction substantially perpendicular with the first plane of the long axis, the plurality of protrusions configured to engage one or more radial spokes on the handwheel; wherein an operator places the central curved portion around the central hub of the handwheel and the plurality of protrusions about one or more radial spokes of the handwheel for engagement;

further wherein the operator turns the elongated shape of the tool by gripping and moving the first handle and the second handle in a counterclockwise direction that is substantially perpendicular with the first plane of the long axis and the direction of the plurality of protrusions, to open the Outside stem and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of protrusions, to close the Outside stem and yoke gate valve; wherein the plurality of protrusions simultaneously apply clockwise force to one or more spokes of the handwheel.

The subject invention discloses a handheld tool for opening and closing outside stem and yoke gate valves for controlling water flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the Outside stem and yoke gate valve; a plurality of protrusions, each protruding in a direction substantially perpendicular with the first plane of the long axis and substantially perpendicular with the central curved portion, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction that is substantially perpendicular with the first plane of the long axis and the direction of the plurality of protrusions, to open the Outside stem and yoke gate valve, wherein the plurality of protrusions simultaneously apply counterclockwise force to one or shape of the tool by gripping and moving the first handle and the second handle in a clockwise direction that is substantially perpendicular with the first plane of the long axis and the direction of the plurality of protrusions, to close the Outside stem and yoke gate valve; wherein the plurality of protrusions simultaneously apply clockwise force to one or more spokes of the handwheel.

The subject invention discloses a handheld tool for opening and closing outside stem and yoke gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion curving in a direction substantially parallel with the first plane of the long axis; a plurality of protrusions, each protruding in a direction substantially perpendicular with the first plane of the long axis, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction to open the Outside stem and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the Outside stem and yoke gate valve; wherein the plurality of protrusions simultaneously apply clockwise force to one or more spokes of the handwheel.

The subject invention discloses a handheld tool for opening and closing outside stem and yoke gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis; a plurality of protrusions, each protruding in a direction substantially perpendicular with the first plane of the long axis and substantially perpendicular with the central arcuate portion, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction to open the Outside stem and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the Outside stem and yoke gate valve; wherein the plurality of protrusions simultaneously apply clockwise force to one or more spokes of the handwheel.

The subject invention discloses a handheld tool for opening and closing outside stem and yoke gate valves for controlling water flow to fire sprinkler systems, the tool comprising: an elongated body having a long axis lying in a first plane with a first end and a second end, wherein the first end and the second end form a first handle and a second handle, respectively; a central arcuate portion curving in a direction substantially parallel with the first plane of the long axis; a plurality of protrusions, each protruding in a direction substantially perpendicular with the first plane of the long axis, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction that is substantially perpendicular with the first plane of the long axis to open the Outside stem and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the Outside stem and yoke gate valve; wherein the plurality of protrusions simultaneously apply clockwise force to one or more spokes of the handwheel.

The subject invention discloses a handheld tool for opening and closing outside stem and yoke gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis; a plurality of protrusions, each protruding in a direction substantially perpendicular with the first plane of the long axis and substantially perpendicular with the arcuate portion, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction that is substantially perpendicular with the first plane of the long axis to open the Outside stem and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the Outside stem and yoke gate valve; wherein the plurality of protrusions simultaneously apply clockwise force to one or more spokes of the handwheel.

The subject invention discloses a handheld tool for opening and closing outside stem and yoke gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion curving in a direction substantially parallel with the first plane of the long axis; a plurality of protrusions, each protruding in a direction substantially perpendicular with the first plane of the long axis, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction that is substantially perpendicular with the first plane of the long axis and the direction of the plurality of protrusions, to open the Outside stem and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of protrusions, to close the Outside stem and yoke gate valve; wherein the plurality of protrusions simultaneously apply clockwise force to one or more spokes of the handwheel.

The subject invention discloses a handheld tool for opening and closing outside stem and yoke gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis; a plurality of protrusions, each protruding in a direction substantially perpendicular with the first plane of the long axis and substantially perpendicular with the central arcuate portion, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction that is substantially perpendicular with the first plane of the long axis and the direction of the plurality of protrusions, to open the Outside stem and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of protrusions, to close the Outside stem and yoke gate valve; wherein the plurality of protrusions simultaneously apply clockwise force to one or more spokes of the handwheel.

The subject invention discloses a handheld tool for opening and closing outside screw and yoke gate valves for controlling water flow to fire sprinkler systems, the tool comprising: an elongated shape with a first end and a second end, wherein the first end and the second end form a first handle and a second handle, respectively; a central curved portion for engaging a central hub on a handwheel of the Outside screw and yoke gate valve; a plurality of protrusions configured to engage one or more spokes on the handwheel; wherein an operator places the central curved portion around the central hub of the handwheel and the plurality of protrusions about one or more spokes of the handwheel for engagement; further wherein the operator turns the elongated shape of the tool by the first handle and the second handle in a counterclockwise direction to open the Outside screw and yoke gate valve, wherein the plurality of protrusions simultaneously apply counterclockwise force to one or more spokes of the handwheel; further wherein the operator turns the elongated shape of the tool by the first handle and the second handle in a clockwise direction to close the Outside screw and yoke gate valve; wherein the plurality of protrusions simultaneously apply clockwise force to one or more spokes of the handwheel.

The subject invention discloses a handheld tool for opening and closing outside screw and yoke gate valves for controlling water flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the Outside screw and yoke gate valve; a plurality of protrusions, each protruding in a direction substantially perpendicular with the first plane of the long axis, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction to open the Outside screw and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the Outside screw and yoke gate valve; wherein the plurality of protrusions simultaneously apply clockwise force to one or more spokes of the handwheel.

The subject invention discloses a handheld tool for opening and closing outside screw and yoke gate valves for controlling water flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the Outside screw and yoke gate valve; a plurality of protrusions, each protruding in a direction substantially perpendicular with the first plane of the long axis and substantially perpendicular with the central curved portion, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction to open the Outside screw and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the Outside screw and yoke gate valve; wherein the plurality of protrusions simultaneously apply clockwise force to one or more spokes of the handwheel.

The subject invention discloses a handheld tool for opening and closing outside screw and yoke gate valves for controlling water flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the Outside screw and yoke gate valve; a plurality of protrusions, each protruding in a direction substantially perpendicular with the first plane of the long axis, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction that is substantially perpendicular with the first plane of the long axis to open the Outside screw and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the Outside screw and yoke gate valve; wherein the plurality of protrusions simultaneously apply clockwise force to one or more spokes of the handwheel.

The subject invention discloses a handheld tool for opening and closing outside screw and yoke gate valves for controlling water flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the Outside screw and yoke gate valve; a plurality of protrusions, each protruding in a direction substantially perpendicular with the first plane of the long axis and substantially perpendicular with the central curved portion, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction that is substantially perpendicular with the first plane of the long axis to open the Outside screw and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the Outside screw and yoke gate valve; wherein the plurality of protrusions simultaneously apply clockwise force to one or more spokes of the handwheel.

The subject invention discloses a handheld tool for opening and closing outside screw and yoke gate valves for controlling water flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the Outside screw and yoke gate valve; a plurality of protrusions, each protruding in a direction substantially perpendicular with the first plane of the long axis, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction that is substantially perpendicular with the first plane of the long axis and the direction of the plurality of protrusions, to open the Outside screw and yoke gate valve, wherein the plurality of protrusions simultaneously apply counterclockwise force to one or shape of the tool by gripping and moving the first handle and the second handle in a clockwise direction that is substantially perpendicular with the first plane of the long axis and the direction of the plurality of protrusions, to close the Outside screw and yoke gate valve; wherein the plurality of protrusions simultaneously apply clockwise force to one or more spokes of the handwheel.

The subject invention discloses a handheld tool for opening and closing outside screw and yoke gate valves for controlling water flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the Outside screw and yoke gate valve; a plurality of protrusions, each protruding in a direction substantially perpendicular with the first plane of the long axis and substantially perpendicular with the central curved portion, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction that is substantially perpendicular with the first plane of the long axis and the direction of the plurality of protrusions, to open the Outside screw and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of protrusions, to close the Outside screw and yoke gate valve; wherein the plurality of protrusions simultaneously apply clockwise force to one or more spokes of the handwheel.

The subject invention discloses a handheld tool for opening and closing outside screw and yoke gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion curving in a direction substantially parallel with the first plane of the long axis; a plurality of protrusions, each protruding in a direction substantially perpendicular with the first plane of the long axis, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction to open the Outside screw and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the Outside screw and yoke gate valve; wherein the plurality of protrusions simultaneously apply clockwise force to one or more spokes of the handwheel.

The subject invention discloses a handheld tool for opening and closing outside screw and yoke gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis; a plurality of protrusions, each protruding in a direction substantially perpendicular with the first plane of the long axis and substantially perpendicular with the central arcuate portion, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction to open the Outside screw and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the Outside screw and yoke gate valve; wherein the plurality of protrusions simultaneously apply clockwise force to one or more spokes of the handwheel.

The subject invention discloses a handheld tool for opening and closing outside screw and yoke gate valves for controlling water flow to fire sprinkler systems, the tool comprising: an elongated body having a long axis lying in a first plane with a first end and a second end, wherein the first end and the second end form a first handle and a second handle, respectively; a central arcuate portion curving in a direction substantially parallel with the first plane of the long axis; a plurality of protrusions, each protruding in a direction substantially perpendicular with the first plane of the long axis, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction that is substantially perpendicular with the first plane of the long axis to open the Outside screw and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the Outside screw and yoke gate valve; wherein the plurality of protrusions simultaneously apply clockwise force to one or more spokes of the handwheel.

The subject invention discloses a handheld tool for opening and closing outside screw and yoke gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis; a plurality of protrusions, each protruding in a direction substantially perpendicular with the first plane of the long axis and substantially perpendicular with the arcuate portion, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction that is substantially perpendicular with the first plane of the long axis to open the Outside screw and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the Outside screw and yoke gate valve; wherein the plurality of protrusions simultaneously apply clockwise force to one or more spokes of the handwheel.

The subject invention discloses a handheld tool for opening and closing outside screw and yoke gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion curving in a direction substantially parallel with the first plane of the long axis; a plurality of protrusions, each protruding in a direction substantially perpendicular with the first plane of the long axis, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction that is substantially perpendicular with the first plane of the long axis and the direction of the plurality of protrusions, to open the Outside screw and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of protrusions, to close the Outside screw and yoke gate valve; wherein the plurality of protrusions simultaneously apply clockwise force to one or more spokes of the handwheel.

The subject invention discloses a handheld tool for opening and closing outside screw and yoke gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis; a plurality of protrusions, each protruding in a direction substantially perpendicular with the first plane of the long axis and substantially perpendicular with the central arcuate portion, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction that is substantially perpendicular with the first plane of the long axis and the direction of the plurality of protrusions, to open the Outside screw and yoke gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of protrusions, to close the Outside screw and yoke gate valve; wherein the plurality of protrusions simultaneously apply clockwise force to one or more spokes of the handwheel.

The subject invention discloses a handheld tool for opening and closing water gate valves for controlling water flow to fire sprinkler systems, the tool comprising: an elongated shape with a first end and a second end, wherein the first end and the second end form a first handle and a second handle, respectively; a central curved portion for engaging a central hub on a handwheel of the Water gate valve; a plurality of protrusions configured to engage one or more spokes on the handwheel; wherein an operator places the central curved portion around the central hub of the handwheel and the plurality of protrusions about one or more spokes of the handwheel for engagement; further wherein the operator turns the elongated shape of the tool by the first handle and the second handle in a counterclockwise direction to open the Water gate valve, wherein the plurality of protrusions simultaneously apply counterclockwise force to one or more spokes of the handwheel; further wherein the operator turns the elongated shape of the tool by the first handle and the second handle in a clockwise direction to close the Water gate valve; wherein the plurality of protrusions simultaneously apply clockwise force to one or more spokes of the handwheel.

The subject invention discloses a handheld tool for opening and closing water gate valves for controlling water flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the Water gate valve; a plurality of protrusions, each protruding in a direction substantially perpendicular with the first plane of the long axis, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction to open the Water gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the Water gate valve; wherein the plurality of protrusions simultaneously apply clockwise force to one or more spokes of the handwheel.

The subject invention discloses a handheld tool for opening and closing water gate valves for controlling water flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the Water gate valve; a plurality of protrusions, each protruding in a direction substantially perpendicular with the first plane of the long axis and substantially perpendicular with the central curved portion, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction to open the Water gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the Water gate valve; wherein the plurality of protrusions simultaneously apply clockwise force to one or more spokes of the handwheel.

The subject invention discloses a handheld tool for opening and closing water gate valves for controlling water flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the Water gate valve; a plurality of protrusions, each protruding in a direction substantially perpendicular with the first plane of the long axis, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction that is substantially perpendicular with the first plane of the long axis to open the Water gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the Water gate valve; wherein the plurality of protrusions simultaneously apply clockwise force to one or more spokes of the handwheel.

The subject invention discloses a handheld tool for opening and closing water gate valves for controlling water flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the Water gate valve; a plurality of protrusions, each protruding in a direction substantially perpendicular with the first plane of the long axis and substantially perpendicular with the central curved portion, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction that is substantially perpendicular with the first plane of the long axis to open the Water gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the Water gate valve; wherein the plurality of protrusions simultaneously apply clockwise force to one or more spokes of the handwheel.

The subject invention discloses a handheld tool for opening and closing water gate valves for controlling water flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the Water gate valve; a plurality of protrusions, each protruding in a direction substantially perpendicular with the first plane of the long axis, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction that is substantially perpendicular with the first plane of the long axis and the direction of the plurality of protrusions, to open the Water gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of protrusions, to close the Water gate valve; wherein the plurality of protrusions simultaneously apply clockwise force to one or more spokes of the handwheel.

The subject invention discloses a handheld tool for opening and closing water gate valves for controlling water flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the Water gate valve; a plurality of protrusions, each protruding in a direction substantially perpendicular with the first plane of the long axis and substantially perpendicular with the central curved portion, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction that is substantially perpendicular with the first plane of the long axis and the direction of the plurality of protrusions, to open the Water gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of protrusions, to close the Water gate valve; wherein the plurality of protrusions simultaneously apply clockwise force to one or more spokes of the handwheel.

The subject invention discloses a handheld tool for opening and closing water gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion curving in a direction substantially parallel with the first plane of the long axis; a plurality of protrusions, each protruding in a direction substantially perpendicular with the first plane of the long axis, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction to open the Water gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the Water gate valve; wherein the plurality of protrusions simultaneously apply clockwise force to one or more spokes of the handwheel.

The subject invention discloses a handheld tool for opening and closing water gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis; a plurality of protrusions, each protruding in a direction substantially perpendicular with the first plane of the long axis and substantially perpendicular with the central arcuate portion, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction to open the Water gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the Water gate valve; wherein the plurality of protrusions simultaneously apply clockwise force to one or more spokes of the handwheel.

The subject invention discloses a handheld tool for opening and closing water gate valves for controlling water flow to fire sprinkler systems, the tool comprising: an elongated body having a long axis lying in a first plane with a first end and a second end, wherein the first end and the second end form a first handle and a second handle, respectively; a central arcuate portion curving in a direction substantially parallel with the first plane of the long axis; a plurality of protrusions, each protruding in a direction substantially perpendicular with the first plane of the long axis, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction that is substantially perpendicular with the first plane of the long axis to open the Water gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the Water gate valve; wherein the plurality of protrusions simultaneously apply clockwise force to one or more spokes of the handwheel.

The subject invention discloses a handheld tool for opening and closing water gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis; a plurality of protrusions, each protruding in a direction substantially perpendicular with the first plurality of protrusions configured to grip one or more interior surfaces of radial around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction that is substantially perpendicular with the first plane of the long axis to open the Water gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the Water gate valve; wherein the plurality of protrusions simultaneously apply clockwise force to one or more spokes of the handwheel.

The subject invention discloses a handheld tool for opening and closing water gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion curving in a direction substantially parallel with the first plane of the long axis; a plurality of protrusions, each protruding in a direction substantially perpendicular with the first plane of the long axis, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise the direction of the plurality of protrusions, to open the Water gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of protrusions, to close the Water gate valve; wherein the plurality of protrusions simultaneously apply clockwise force to one or more spokes of the handwheel.

The subject invention discloses a handheld tool for opening and closing water gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis; a plurality of protrusions, each protruding in a direction substantially perpendicular with the first plane of the long axis and substantially perpendicular with the central arcuate portion, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction that is substantially perpendicular with the first plane of the long axis and the direction of the plurality of protrusions, to open the Water gate valve, wherein the plurality of protrusions simultaneously apply counterclockwise force to one or more spokes of the handwheel; further wherein the operator turns the elongated shape of the tool by gripping and moving the first handle and the second handle in a clockwise the direction of the plurality of protrusions, to close the Water gate valve; wherein the plurality of protrusions simultaneously apply clockwise force to one or more spokes of the handwheel.

The subject invention discloses a handheld tool for opening and closing fluid gate valves for controlling fluid flow to fire sprinkler systems, the tool comprising: an elongated shape with a first end and a second end, wherein the first end and the second end form a first handle and a second handle, respectively; a central curved portion for engaging a central hub on a handwheel of the Fluid gate valve; a plurality of protrusions configured to engage one or more spokes on the handwheel; wherein an operator places the central curved portion around the central hub of the handwheel and the plurality of protrusions about one or more spokes of the handwheel for engagement; further wherein the operator turns the elongated shape of the tool by the first handle and the second handle in a counterclockwise direction to open the Fluid gate valve, wherein the plurality of protrusions simultaneously apply counterclockwise force to one or more spokes of the handwheel; further wherein the operator turns the elongated shape of the tool by the first handle and the second handle in a clockwise direction to close the Fluid gate valve; wherein the plurality of protrusions simultaneously apply clockwise force to one or more spokes of the handwheel.

The subject invention discloses a handheld tool for opening and closing fluid gate valves for controlling fluid flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the Fluid gate valve; a plurality of protrusions, each protruding in a direction substantially perpendicular with the first plane of the long axis, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction to open the Fluid gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the Fluid gate valve; wherein the plurality of protrusions simultaneously apply clockwise force to one or more spokes of the handwheel.

The subject invention discloses a handheld tool for opening and closing fluid gate valves for controlling fluid flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the Fluid gate valve; a plurality of protrusions, each protruding in a direction substantially perpendicular with the first plane of the long axis and substantially perpendicular with the central curved portion, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction to open the Fluid gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the Fluid gate valve; wherein the plurality of protrusions simultaneously apply clockwise force to one or more spokes of the handwheel.

The subject invention discloses a handheld tool for opening and closing fluid gate valves for controlling fluid flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the Fluid gate valve; a plurality of protrusions, each protruding in a direction substantially perpendicular with the first plane of the long axis, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction that is substantially perpendicular with the first plane of the long axis to open the Fluid gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the Fluid gate valve; wherein the plurality of protrusions simultaneously apply clockwise force to one or more spokes of the handwheel.

The subject invention discloses a handheld tool for opening and closing fluid gate valves for controlling fluid flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the Fluid gate valve; a plurality of protrusions, each protruding in a direction substantially perpendicular with the first plane of the long axis and substantially perpendicular with the central curved portion, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction that is substantially perpendicular with the first plane of the long axis to open the Fluid gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the Fluid gate valve; wherein the plurality of protrusions simultaneously apply clockwise force to one or more spokes of the handwheel.

The subject invention discloses a handheld tool for opening and closing fluid gate valves for controlling fluid flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the Fluid gate valve; a plurality of protrusions, each protruding in a direction substantially perpendicular with the first plane of the long axis, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction that is substantially perpendicular with the first plane of the long axis and the direction of the plurality of protrusions, to open the Fluid gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of protrusions, to close the Fluid gate valve; wherein the plurality of protrusions simultaneously apply clockwise force to one or more spokes of the handwheel.

The subject invention discloses a handheld tool for opening and closing fluid gate valves for controlling fluid flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the Fluid gate valve; a plurality of protrusions, each protruding in a direction substantially perpendicular with the first plane of the long axis and substantially perpendicular with the central curved portion, the plurality of protrusions configured to engage one or more radial spokes on the handwheel; wherein an operator places the central curved portion around the central hub of the handwheel and the plurality of protrusions about one or more radial spokes of the handwheel for engagement; further wherein the operator turns the elongated shape of the tool by gripping and moving the first handle and the second handle in a counterclockwise direction that is substantially perpendicular with the first plane of the long axis and the direction of the plurality of protrusions, to open the Fluid gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of protrusions, to close the Fluid gate valve; wherein the plurality of protrusions simultaneously apply clockwise force to one or more spokes of the handwheel.

The subject invention discloses a handheld tool for opening and closing fluid gate valves for controlling fluid flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion curving in a direction substantially parallel with the first plane of the long axis; a plurality of protrusions, each protruding in a direction substantially perpendicular with the first plane of the long axis, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction to open the Fluid gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the Fluid gate valve; wherein the plurality of protrusions simultaneously apply clockwise force to one or more spokes of the handwheel.

The subject invention discloses a handheld tool for opening and closing fluid gate valves for controlling fluid flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis; a plurality of protrusions, each protruding in a direction substantially perpendicular with the first plane of the long axis and substantially perpendicular with the central arcuate portion, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction to open the Fluid gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the Fluid gate valve; wherein the plurality of protrusions simultaneously apply clockwise force to one or more spokes of the handwheel.

The subject invention discloses a handheld tool for opening and closing fluid gate valves for controlling fluid flow to fire sprinkler systems, the tool comprising: an elongated body having a long axis lying in a first plane with a first end and a second end, wherein the first end and the second end form a first handle and a second handle, respectively; a central arcuate portion curving in a direction substantially parallel with the first plane of the long axis; a plurality of protrusions, each protruding in a direction substantially perpendicular with the first plane of the long axis, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction that is substantially perpendicular with the first plane of the long axis to open the Fluid gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the Fluid gate valve; wherein the plurality of protrusions simultaneously apply clockwise force to one or more spokes of the handwheel.

The subject invention discloses a handheld tool for opening and closing fluid gate valves for controlling fluid flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis; a plurality of protrusions, each protruding in a direction substantially perpendicular with the first plane of the long axis and substantially perpendicular with the arcuate portion, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction that is substantially perpendicular with the first plane of the long axis to open the Fluid gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the Fluid gate valve; wherein the plurality of protrusions simultaneously apply clockwise force to one or more spokes of the handwheel.

The subject invention discloses a handheld tool for opening and closing fluid gate valves for controlling fluid flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion curving in a direction substantially parallel with the first plane of the long axis; a plurality of protrusions, each protruding in a direction substantially perpendicular with the first plane of the long axis, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction that is substantially perpendicular with the first plane of the long axis and the direction of the plurality of protrusions, to open the Fluid gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of protrusions, to close the Fluid gate valve; wherein the plurality of protrusions simultaneously apply clockwise force to one or more spokes of the handwheel.

The subject invention discloses a handheld tool for opening and closing fluid gate valves for controlling fluid flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis; a plurality of protrusions, each protruding in a direction substantially perpendicular with the first plane of the long axis and substantially perpendicular with the central arcuate portion, the plurality of protrusions configured to grip one or more interior surfaces of radial spokes on the handwheel; wherein the operator places the central arcuate portion around a central hub of the handwheel and the plurality of protrusions about one or more radial spokes of the handwheel for engagement, wherein one or more of the plurality of protrusions grips one or more interior surfaces of radial spokes on the handwheel; further wherein the operator turns the elongated shape of the tool by gripping and moving the first handle and the second handle in a counterclockwise direction that is substantially perpendicular with the first plane of the long axis and the direction of the plurality of protrusions, to open the Fluid gate valve, wherein the plurality of protrusions simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of protrusions, to close the Fluid gate valve; wherein the plurality of protrusions simultaneously apply clockwise force to one or more spokes of the handwheel.

The subject invention discloses a handheld tool for opening and closing OS&Y gate valves for controlling water flow to fire sprinkler systems, the tool comprising: an elongated shape with a first end and a second end, wherein the first end and the second end form a first handle and a second handle, respectively; a central curved portion for engaging a central hub on a handwheel of the OS&Y gate valve; a plurality of projections configured to engage one or more spokes on the handwheel; wherein an operator places the central curved portion around the central hub of the handwheel and the plurality of projections about one or more spokes of the handwheel for engagement; further wherein the operator turns the elongated shape of the tool by the first handle and the second handle in a counterclockwise direction to open the OS&Y gate valve, wherein the plurality of projections simultaneously apply counterclockwise force to one or more spokes of the handwheel; further wherein the operator turns the elongated shape of the tool by the first handle and the second handle in a clockwise direction to close the OS&Y gate valve; wherein the plurality of projections simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the OS&Y gate valve; a plurality of projections, each protruding in a direction substantially perpendicular with the first plane of the long axis, the plurality of projections configured to engage one or more radial spokes on the handwheel; wherein an operator places the central curved portion around the central hub of the handwheel and the plurality of projections about one or more radial spokes of the handwheel for engagement; further wherein the operator turns the elongated shape of the tool by gripping and moving the first handle and the second handle in a counterclockwise direction to open the OS&Y gate valve, wherein the plurality of projections simultaneously apply counterclockwise force to one or more spokes of the handwheel; further wherein the operator turns the elongated shape of the tool by gripping and moving the first handle and the second handle in a clockwise direction to close the OS&Y gate valve; wherein the plurality of projections simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the OS&Y gate valve; a plurality of projections, each protruding in a direction substantially perpendicular with the first plane of the long axis and substantially perpendicular with the central curved portion, the plurality of projections configured to engage one or more radial spokes on the handwheel; wherein an operator places the central curved portion around the central hub of the handwheel and the plurality of projections about one or more radial spokes of the handwheel for engagement; further wherein the operator turns the elongated shape of the tool by gripping and moving the first handle and the second handle in a counterclockwise direction to open the OS&Y gate valve, wherein the plurality of projections simultaneously apply counterclockwise force to one or more spokes of the handwheel; further wherein the operator turns the elongated shape of the tool by gripping and moving the first handle and the second handle in a clockwise direction to close the OS&Y gate valve; wherein the plurality of projections simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the OS&Y gate valve; a plurality of projections, each protruding in a direction substantially perpendicular with the first plane of the long axis, the plurality of projections configured to engage one or more radial spokes on the handwheel; wherein an operator places the central curved portion around the central hub of the handwheel and the plurality of projections about one or more radial spokes of the handwheel for engagement; further wherein the operator turns the elongated shape of the tool by gripping and moving the first handle and the second handle in a counterclockwise direction that is substantially perpendicular with the first plane of the long axis to open the OS&Y gate valve, wherein the plurality of projections simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the OS&Y gate valve; wherein the plurality of projections simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the OS&Y gate valve; a plurality of projections, each protruding in a direction substantially perpendicular with the first plane of the long axis and substantially perpendicular with the central curved portion, the plurality of projections configured to engage one or more radial spokes on the handwheel; wherein an operator places the central curved portion around the central hub of the handwheel and the plurality of projections about one or more radial spokes of the handwheel for engagement; further wherein the operator turns the elongated shape of the tool by gripping and moving the first handle and the second handle in a counterclockwise direction that is substantially perpendicular with the first plane of the long axis to open the OS&Y gate valve, wherein the plurality of projections simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the OS&Y gate valve; wherein the plurality of projections simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the OS&Y gate valve; a plurality of projections, each protruding in a direction substantially perpendicular with the first plane of the long axis, the plurality of projections configured to engage one or more radial spokes on the handwheel; wherein an operator places the central curved portion around the central hub of the handwheel and the plurality of projections about one or more radial spokes of the handwheel for engagement; further wherein the operator turns the elongated shape of the tool by gripping and moving the first handle and the second handle in a counterclockwise direction that is substantially perpendicular with the first plane of the long axis and the direction of the plurality of projections, to open the OS&Y gate valve, wherein the plurality of projections simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of projections, to close the OS&Y gate valve; wherein the plurality of projections simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the OS&Y gate valve; a plurality of projections, each protruding in a direction substantially perpendicular with the first plane of the long axis and substantially perpendicular with the central curved portion, the plurality of projections configured to engage one or more radial spokes on the handwheel; wherein an operator places the central curved portion around the central hub of the handwheel and the plurality of projections about one or more radial spokes of the handwheel for engagement; further wherein the operator turns the elongated shape of the tool by gripping and moving the first handle and the second handle in a counterclockwise direction that is substantially perpendicular with the first plane of the long axis and the direction of the plurality of projections, to open the OS&Y gate valve, wherein the plurality of projections simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of projections, to close the OS&Y gate valve; wherein the plurality of projections simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion curving in a direction substantially parallel with the first plane of the long axis, a plurality of projections, each protruding in a direction substantially perpendicular with the first plane of the long axis, the plurality of projections configured to grip one or more interior surfaces of radial spokes on the handwheel; wherein the operator places the central arcuate portion around a central hub of the handwheel and the plurality of projections about one or more radial spokes of the handwheel for engagement, wherein one or more of the plurality of projections grips one or more interior surfaces of radial spokes on the handwheel; further wherein the operator turns the elongated shape of the tool by gripping and moving the first handle and the second handle in a counterclockwise direction to open the OS&Y gate valve, wherein the plurality of projections simultaneously apply counterclockwise force to one or more spokes of the handwheel; further wherein the operator turns the elongated shape of the tool by gripping and moving the first handle and the second handle in a clockwise direction to close the OS&Y gate valve; wherein the plurality of projections simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis, a plurality of projections, each protruding in a direction substantially perpendicular with the first plane of the long axis and substantially perpendicular with the central arcuate portion, the plurality of projections configured to grip one or more interior surfaces of radial spokes on the handwheel; wherein the operator places the central arcuate portion around a central hub of the handwheel and the plurality of projections about one or more radial spokes of the handwheel for engagement, wherein one or more of the plurality of projections grips one or more interior surfaces of radial spokes on the handwheel; further wherein the operator turns the elongated shape of the tool by gripping and moving the first handle and the second handle in a counterclockwise direction to open the OS&Y gate valve, wherein the plurality of projections simultaneously apply counterclockwise force to one or more spokes of the handwheel; further wherein the operator turns the elongated shape of the tool by gripping and moving the first handle and the second handle in a clockwise direction to close the OS&Y gate valve; wherein the plurality of projections simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central arcuate portion curving in a direction substantially parallel with the first plane of the long axis, a plurality of projections, each protruding in a direction substantially perpendicular with the first plane of the long axis, the plurality of projections configured to grip one or more interior surfaces of radial spokes on the handwheel; wherein the operator places the central arcuate portion around a central hub of the handwheel and the plurality of projections about one or more radial spokes of the handwheel for engagement, wherein one or more of the plurality of projections grips one or more interior surfaces of radial spokes on the handwheel; further wherein the operator turns the elongated shape of the tool by gripping and moving the first handle and the second handle in a counterclockwise direction that is substantially perpendicular with the first plane of the long axis to open the OS&Y gate valve, wherein the plurality of projections simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the OS&Y gate valve; wherein the plurality of projections simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis, a plurality of projections, each protruding in a direction substantially perpendicular with the first plurality of projections configured to grip one or more interior surfaces of radial around a central hub of the handwheel and the plurality of projections about one or more radial spokes of the handwheel for engagement, wherein one or more of the plurality of projections grips one or more interior surfaces of radial spokes on the handwheel; further wherein the operator turns the elongated shape of the tool by gripping and moving the first handle and the second handle in a counterclockwise direction that is substantially perpendicular with the first plane of the long axis to open the OS&Y gate valve, wherein the plurality of projections simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the OS&Y gate valve; wherein the plurality of projections simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion curving in a direction substantially parallel with the first plane of the long axis, a plurality of projections, each protruding in a direction substantially perpendicular with the first plane of the long axis, the plurality of projections configured to grip one or more interior surfaces of radial spokes on the handwheel; wherein the operator places the central arcuate portion around a central hub of the handwheel and the plurality of projections about one or more radial spokes of the handwheel for engagement, wherein one or more of the plurality of projections grips one or more interior surfaces of radial spokes on the handwheel; further wherein the operator turns the elongated shape of the tool by gripping and moving the first handle and the second handle in a counterclockwise the direction of the plurality of projections, to open the OS&Y gate valve, wherein the plurality of projections simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of projections, to close the OS&Y gate valve; wherein the plurality of projections simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis, a plurality of projections, each protruding in a direction substantially perpendicular with the first plane of the long axis and substantially perpendicular with the central arcuate portion, the plurality of projections configured to grip one or more interior surfaces of radial spokes on the handwheel; wherein the operator places the central arcuate portion around a central hub of the handwheel and the plurality of projections about one or more radial spokes of the handwheel for engagement, wherein one or more of the plurality of projections grips one or more interior surfaces of radial spokes on the handwheel; further wherein the operator turns the elongated shape of the tool by gripping and moving the first handle and the second handle in a counterclockwise direction that is substantially perpendicular with the first plane of the long axis and the direction of the plurality of projections, to open the OS&Y gate valve, wherein the plurality of projections simultaneously apply counterclockwise force to one or more spokes of the handwheel; further wherein the operator turns the elongated shape of the tool by gripping and moving the first handle and the second handle in a clockwise the direction of the plurality of projections, to close the OS&Y gate valve; wherein the plurality of projections simultaneously apply clockwise force to one or more spokes of the handwheel.

The subject invention discloses a handheld tool for opening and closing OS&Y gate valves for controlling water flow to fire sprinkler systems, the tool comprising: an elongated shape with a first end and a second end, wherein the first end and the second end form a first handle and a second handle, respectively; a central curved portion for engaging a central hub on a handwheel of the OS&Y gate valve; a plurality of pegs configured to engage one or more spokes on the handwheel; wherein an operator places the central curved portion around the central hub of the handwheel and the plurality of pegs about one or more spokes of the handwheel for engagement; further wherein the operator turns the elongated shape of the tool by the first handle and the second handle in a counterclockwise direction to open the OS&Y gate valve, wherein the plurality of pegs simultaneously apply counterclockwise force to one or more spokes of the handwheel; further wherein the operator turns the elongated shape of the tool by the first handle and the second handle in a clockwise direction to close the OS&Y gate valve; wherein the plurality of pegs simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the OS&Y gate valve; a plurality of pegs, each protruding in a direction substantially perpendicular with the first plane of the long axis, the plurality of pegs configured to engage one or more radial spokes on the handwheel; wherein an operator places the central curved portion around the central hub of the handwheel and the plurality of pegs about one or more radial spokes of the handwheel for engagement; further wherein the operator turns the elongated shape of the tool by gripping and moving the first handle and the second handle in a counterclockwise direction to open the OS&Y gate valve, wherein the plurality of pegs simultaneously apply counterclockwise force to one or more spokes of the handwheel; further wherein the operator turns the elongated shape of the tool by gripping and moving the first handle and the second handle in a clockwise direction to close the OS&Y gate valve; wherein the plurality of pegs simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the OS&Y gate valve; a plurality of pegs, each protruding in a direction substantially perpendicular with the first plane of the long axis and substantially perpendicular with the central curved portion, the plurality of pegs configured to engage one or more radial spokes on the handwheel; wherein an operator places the central curved portion around the central hub of the handwheel and the plurality of pegs about one or more radial spokes of the handwheel for engagement; further wherein the operator turns the elongated shape of the tool by gripping and moving the first handle and the second handle in a counterclockwise direction to open the OS&Y gate valve, wherein the plurality of pegs simultaneously apply counterclockwise force to one or more spokes of the handwheel; further wherein the operator turns the elongated shape of the tool by gripping and moving the first handle and the second handle in a clockwise direction to close the OS&Y gate valve; wherein the plurality of pegs simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the OS&Y gate valve; a plurality of pegs, each protruding in a direction substantially perpendicular with the first plane of the long axis, the plurality of pegs configured to engage one or more radial spokes on the handwheel; wherein an operator places the central curved portion around the central hub of the handwheel and the plurality of pegs about one or more radial spokes of the handwheel for engagement; further wherein the operator turns the elongated shape of the tool by gripping and moving the first handle and the second handle in a counterclockwise direction that is substantially perpendicular with the first plane of the long axis to open the OS&Y gate valve, wherein the plurality of pegs simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the OS&Y gate valve; wherein the plurality of pegs simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the OS&Y gate valve; a plurality of pegs, each protruding in a direction substantially perpendicular with the first plane of the long axis and substantially perpendicular with the central curved portion, the plurality of pegs configured to engage one or more radial spokes on the handwheel; wherein an operator places the central curved portion around the central hub of the handwheel and the plurality of pegs about one or more radial spokes of the handwheel for engagement; further wherein the operator turns the elongated shape of the tool by gripping and moving the first handle and the second handle in a counterclockwise direction that is substantially perpendicular with the first plane of the long axis to open the OS&Y gate valve, wherein the plurality of pegs simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the OS&Y gate valve; wherein the plurality of pegs simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central curved portion curving in a direction substantially parallel with the first plane of the long axis, the central curved portion for engaging a central hub on a handwheel of the OS&Y gate valve; a plurality of pegs, each protruding in a direction substantially perpendicular with the first plane of the long axis, the plurality of pegs configured to engage one or more radial spokes on the handwheel; wherein an operator places the central curved portion around the central hub of the handwheel and the plurality of pegs about one or more radial spokes of the handwheel for engagement; further wherein the operator turns the elongated shape of the tool by gripping and moving the first handle and the second handle in a counterclockwise direction that is substantially perpendicular with the first plane of the long axis and the direction of the plurality of pegs, to open the OS&Y gate valve, wherein the plurality of pegs simultaneously apply counterclockwise force to one or shape of the tool by gripping and moving the first handle and the second handle in a clockwise direction that is substantially perpendicular with the first plane of the long axis and the direction of the plurality of pegs, to close the OS&Y gate valve; wherein the plurality of pegs simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central curved portion, curving in a direction substantially perpendicular with the first plane of the long axis, the central curved portion for engaging a central hub on a handwheel of the OS&Y gate valve; a plurality of pegs, each protruding in a direction substantially perpendicular with the first plane of the long axis and substantially perpendicular with the central curved portion, the plurality of pegs configured to engage one or more radial spokes on the handwheel; wherein an operator places the central curved portion around the central hub of the handwheel and the plurality of pegs about one or more radial spokes of the handwheel for engagement; further wherein the operator turns the elongated shape of the tool by gripping and moving the first handle and the second handle in a counterclockwise direction that is substantially perpendicular with the first plane of the long axis and the direction of the plurality of pegs, to open the OS&Y gate valve, wherein the plurality of pegs simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of pegs, to close the OS&Y gate valve; wherein the plurality of pegs simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion curving in a direction substantially parallel with the first plane of the long axis, a plurality of pegs, each protruding in a direction substantially perpendicular with the first plane of the long axis, the plurality of pegs configured to grip one or more interior surfaces of radial spokes on the handwheel; wherein the operator places the central arcuate portion around a central hub of the handwheel and the plurality of pegs about one or more radial spokes of the handwheel for engagement, wherein one or more of the plurality of pegs grips one or more interior surfaces of radial spokes on the handwheel; further wherein the operator turns the elongated shape of the tool by gripping and moving the first handle and the second handle in a counterclockwise direction to open the OS&Y gate valve, wherein the plurality of pegs simultaneously apply counterclockwise force to one or more spokes of the handwheel; further wherein the operator turns the elongated shape of the tool by gripping and moving the first handle and the second handle in a clockwise direction to close the OS&Y gate valve; wherein the plurality of pegs simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis, a plurality of pegs, each protruding in a direction substantially perpendicular with the first plane of the long axis and substantially perpendicular with the central arcuate portion, the plurality of pegs configured to grip one or more interior surfaces of radial spokes on the handwheel; wherein the operator places the central arcuate portion around a central hub of the handwheel and the plurality of pegs about one or more radial spokes of the handwheel for engagement, wherein one or more of the plurality of pegs grips one or more interior surfaces of radial spokes on the handwheel; further wherein the operator turns the elongated shape of the tool by gripping and moving the first handle and the second handle in a counterclockwise direction to open the OS&Y gate valve, wherein the plurality of pegs simultaneously apply counterclockwise force to one or more spokes of the handwheel; further wherein the operator turns the elongated shape of the tool by gripping and moving the first handle and the second handle in a clockwise direction to close the OS&Y gate valve; wherein the plurality of pegs simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively; a central arcuate portion curving in a direction substantially parallel with the first plane of the long axis, a plurality of pegs, each protruding in a direction substantially perpendicular with the first plane of the long axis, the plurality of pegs configured to grip one or more interior surfaces of radial spokes on the handwheel; wherein the operator places the central arcuate portion around a central hub of the handwheel and the plurality of pegs about one or more radial spokes of the handwheel for engagement, wherein one or more of the plurality of pegs grips one or more interior surfaces of radial spokes on the handwheel; further wherein the operator turns the elongated shape of the tool by gripping and moving the first handle and the second handle in a counterclockwise direction that is substantially perpendicular with the first plane of the long axis to open the OS&Y gate valve, wherein the plurality of pegs simultaneously apply counterclockwise force to one or shape of the tool by gripping and moving the first handle and the second handle in a clockwise direction that is substantially perpendicular with the first plane of the long axis to close the OS&Y gate valve; wherein the plurality of pegs simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis, a plurality of pegs, each protruding in a direction substantially perpendicular with the first plane of the long axis and substantially perpendicular with the arcuate portion, the plurality of pegs configured to grip one or more interior surfaces of radial spokes on the handwheel; wherein the operator places the central arcuate portion around a central hub of the handwheel and the plurality of pegs about one or more radial spokes of the handwheel for engagement, wherein one or more of the plurality of pegs grips one or more interior surfaces of radial spokes on the handwheel; further wherein the operator turns the elongated shape of the tool by gripping and moving the first handle and the second handle in a counterclockwise direction that is substantially perpendicular with the first plane of the long axis to open the OS&Y gate valve, wherein the plurality of pegs simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis to close the OS&Y gate valve; wherein the plurality of pegs simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion curving in a direction substantially parallel with the first plane of the long axis, a plurality of pegs, each protruding in a direction substantially perpendicular with the first plane of the long axis, the plurality of pegs configured to grip one or more interior surfaces of radial spokes on the handwheel; wherein the operator places the central arcuate portion around a central hub of the handwheel and the plurality of pegs about one or more radial spokes of the handwheel for engagement, wherein one or more of the plurality of pegs grips one or more interior surfaces of radial spokes on the handwheel; further wherein the operator turns the elongated shape of the tool by gripping and moving the first handle and the second handle in a counterclockwise direction that is substantially perpendicular with the first plane of the long axis and the direction of the plurality of pegs, to open the OS&Y gate valve, wherein the plurality of pegs simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of pegs, to close the OS&Y gate valve; wherein the plurality of pegs simultaneously apply clockwise force to one or more spokes of the handwheel.

The subject invention discloses a handheld tool for opening and closing OS&Y gate valves for controlling water flow to fire sprinkler systems, the tool comprising: an elongated body having a long axis lying in a first plane with a first end and a second end, wherein the first end and the second end form a first handle and a second handle, respectively, wherein the first handle and the second handle are each configured to receive an operator's hands; a central arcuate portion, curving in a direction substantially perpendicular with the first plane of the long axis, a plurality of pegs, each protruding in a direction substantially perpendicular with the first plane of the long axis and substantially perpendicular with the central arcuate portion, the plurality of pegs configured to grip one or more interior surfaces of radial spokes on the handwheel; wherein the operator places the central arcuate portion around a central hub of the handwheel and the plurality of pegs about one or more radial spokes of the handwheel for engagement, wherein one or more of the plurality of pegs grips one or more interior surfaces of radial spokes on the handwheel; further wherein the operator turns the elongated shape of the tool by gripping and moving the first handle and the second handle in a counterclockwise direction that is substantially perpendicular with the first plane of the long axis and the direction of the plurality of pegs, to open the OS&Y gate valve, wherein the plurality of pegs simultaneously apply counterclockwise force to one or more spokes of the handwheel; further wherein the operator turns the elongated shape of the tool by gripping and moving the first handle and the second handle in a clockwise direction that is substantially perpendicular with the first plane of the long axis and the direction of the plurality of pegs, to close the OS&Y gate valve; wherein the plurality of pegs simultaneously apply clockwise force to one or more spokes of the handwheel.

In additional embodiments of the subject invention, the handheld tool may comprise a cast molded unitary piece.

In further embodiments of the subject invention, the handheld tool may comprise a material selected from the group consisting of steel, aluminum-magnesium, or titanium alloy.

In other embodiments of the subject invention, the plurality of protrusions may further comprise teeth on on the plurality of protrusions for enhanced grip.

In further embodiments of the subject invention, the first and second handles of the handheld tool may further comprise high friction surfaces for enhanced enhanced grip.

In additional embodiments of the subject invention, the handheld tool may comprise a total length of 6″ to 48″.

In additional embodiments of the subject invention, the handheld tool may have a cross-sectional configuration selected from square, circular, elliptical, triangular, hexagonal, octagonal, or any suitable cross-sectional shape.

In other embodiments of the subject invention, the central curved portion may comprise a length of 0.5″ to 8″.

In further embodiments of the subject invention, the central curved portion may comprise a height of 0.5″ to 4″.

In additional embodiments of the subject invention, the handheld tool may comprise a height of 0.5″ to 4″.

In further embodiments of the subject invention, the plurality of protrusions each may comprise a width of 0.25″ to 3.5″.

In embodiments of the subject invention, the term “substantially” is defined as at least close to (and can include) a given value or state, as understood by a person of ordinary skill in the art. In one embodiment, the term “substantially” refers to ranges within 10%, preferably within 5%, more preferably within 1%, and most preferably within 0.1% of the given value or state being specified.

In embodiments of the subject invention, the term “relatively” is defined as a comparison of a property, or the proportion of a property between two components.

### BRIEF DESCRIPTION OF THE DRAWINGS

Advantages of the present invention will be apparent from the following detailed description of embodiments, which description should be considered in conjunction with the accompanying drawings, in which:

FIG. 1 Illustrates a top perspective view of a handheld tool for opening and closing OS&Y gate valves.

FIG. 2 Illustrates a bottom perspective view of the handheld tool for opening and closing OS&Y gate valves.

FIG. 3 Illustrates a front view of the handheld tool for opening and closing OS&Y gate valves.

FIG. 4 Illustrates a bottom view of the handheld tool for opening and closing OS&Y gate valves.

FIG. 5 Illustrates a perspective view of the handheld tool when placed on the handwheel of an OS&Y gate valve to be opened.

### DETAILED DESCRIPTION OF THE EMBODIMENTS

While several variations of the present invention have been illustrated by way of example in particular embodiments, it is apparent that further embodiments could be developed within the spirit and scope of the present invention. However, it is to be expressly understood that such modifications and adaptations are within the spirit and scope of the present invention, and are inclusive, but not limited to the following appended claims as set forth.

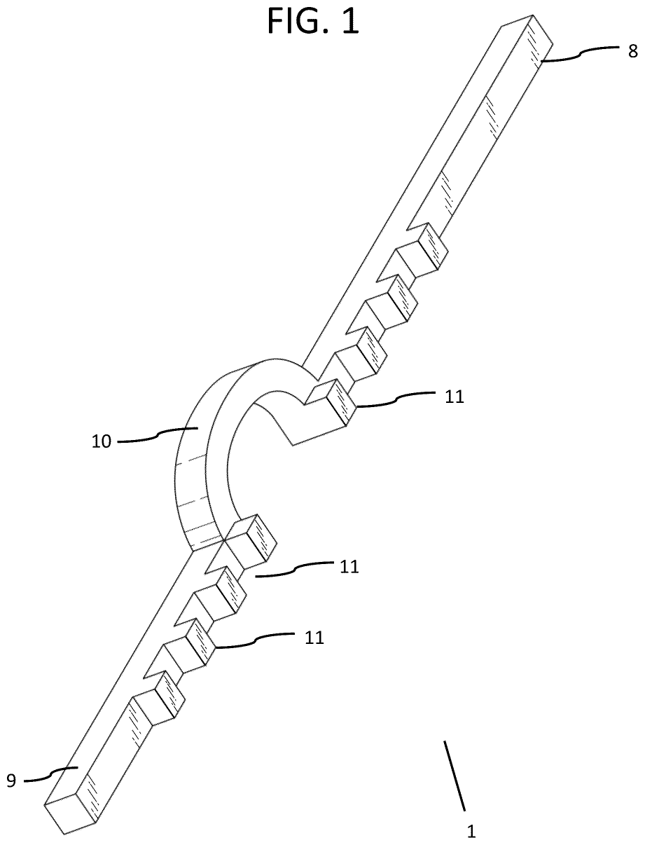

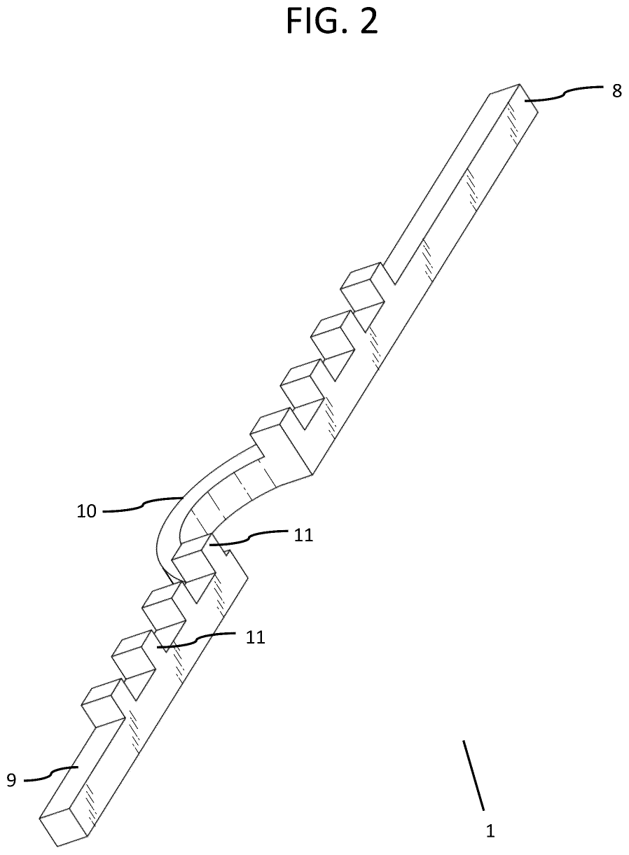

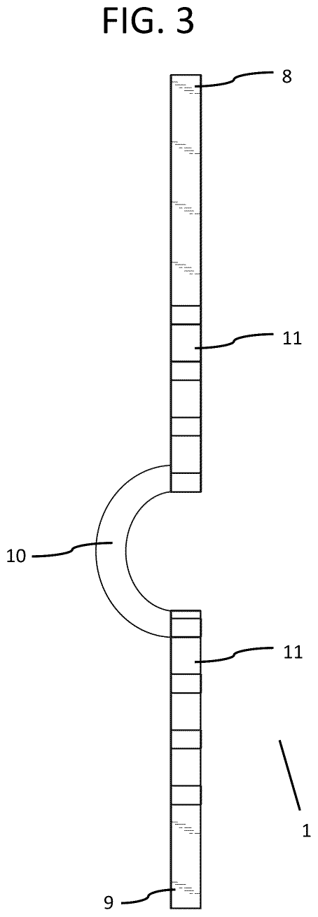

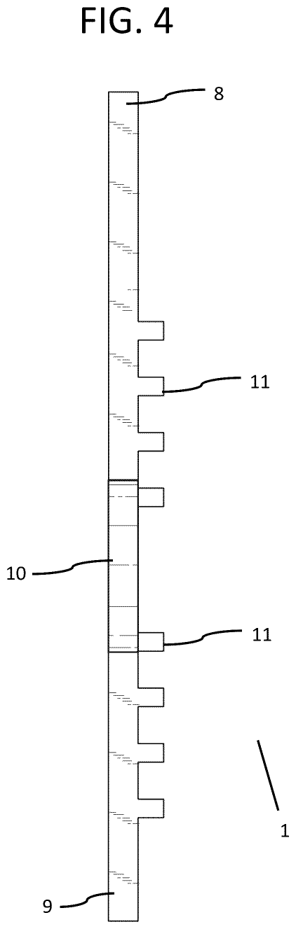

As illustrated in FIG. 1-5, the subject invention is a handheld tool 1 for opening and closing OS&Y (“outside stem and yoke” or “outside screw and yoke”) gate valves 2 commonly used to control water flow to fire sprinkler systems. On an OS&Y gate valve 2, the valve gate is attached to a threaded stem with a handwheel 3 that connects to the yoke element. OS&Y gate valves 2 operate by opening and closing via a gate, which lowers into or rises out of the valve. Raising the gate allows water to flow through the valve while lowering the gate cuts off the water flowing through the valve.

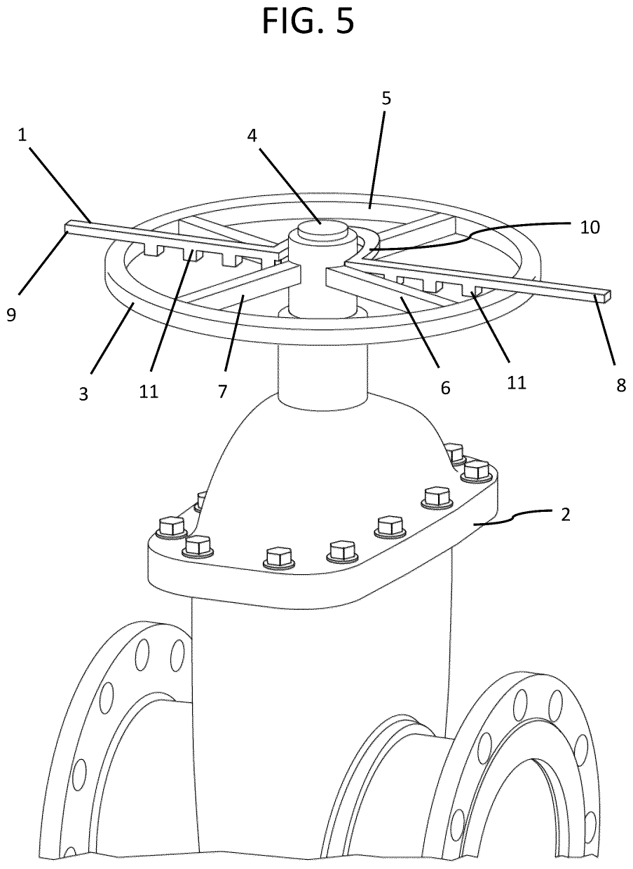

As illustrated in FIG. 5, conventional handwheels 3 on OS&Y gate valves 2 include an inner hub 4, an outer circular rim 5, and a plurality of spokes 6 extending radially between the hub 4 and the rim 5. Each of the spokes 6 includes inner surfaces 7.

The handheld tool 1 is an elongated body having a first end 8 and the second end 9, forming a first handle and a second handle, respectively. In embodiments of the subject invention, the first and second handles of the handheld tool 1 may further comprise high friction surfaces for enhanced enhanced grip. In further embodiments of the subject invention, the handheld tool 1 may be composed of a casted, molded unitary piece of metal or metal alloy, including, but not limited to steel, aluminum-magnesium, or titanium alloy. In additional embodiments of the subject invention, the handheld tool may have a total length of 6″ to 48″. In additional embodiments of the subject invention, the handheld tool may have a height of 0.5″ to 4″. In further embodiments of the subject invention, the handheld tool may have a cross-sectional configuration selected from square, circular, elliptical, triangular, hexagonal, octagonal, or any suitable cross-sectional shape.

The tool 1 further contains a central curved or arcuate portion 10 that curves in a direction substantially parallel with the tool 1 axis. The central curved portion 10 curves around the inner hub 4 of the handwheel 3 when attached to the gate valve 2. In embodiments of the subject invention, the central curved portion 10 may have a length of 0.5″ to 8″ and a height of 0.5″ to 4″.

The tool 1 comprises a plurality of protrusions 11 (or projections or pegs) that each protrude in the same direction, which is substantially perpendicular with the tool 1 axis. The plurality of protrusions 11 are configured to grip one or more inner surfaces 7 of radial spokes 6 on the handwheel 3 of the gate valve 2. In further embodiments of the subject invention, the plurality of protrusions each may be a width of 0.25″ to 3.5″. In embodiments of the subject invention, the plurality of protrusions 11 may have teeth on on the plurality of protrusions for enhanced grip.

To operate the tool 1, the operator places the central arcuate portion 10 around the central hub 4 of the handwheel 3 on the OS&Y gate valve 2. The tool is oriented so the plurality of protrusions 11 face downwards onto the handwheel 3 and grip one or more inner surfaces 7 of the radial spokes 6 of the handwheel 3. Once the protrusions 11 has sufficiently gripped the radial spokes 6, the operator grips and turns the first end 8 and the second end 9 in a counterclockwise direction to open the OS&Y gate valve 2. To close the OS&Y gate valve 2, the operator grips and turns the first end 8 and the second end 9 in a clockwise direction. During this counterclockwise or clockwise movement, the central arcuate portion 10 moves around the central hub 4 of the handwheel 3.

What is claimed is:

1. A handheld tool for opening and closing OS&Y gate valves for controlling water flow to fire sprinkler systems, the tool comprising: an elongated member having a long axis lying in a first plane with a first end and a second end, wherein the first end and the second end form a first handle and a second handle, respectively; a central curved portion curving in a direction substantially parallel with the first plane of the long axis; a plurality of protrusions, each protruding in a direction substantially perpendicular with the first plane of the long axis, the plurality of protrusions configured to engage one or more radial spokes on the handwheel; wherein an operator places the central curved portion around a central hub of the handwheel and the plurality of protrusions about one or more radial spokes of the handwheel for engagement; further wherein the operator turns the elongated shape of the tool by gripping and moving the first handle and the second handle in a counterclockwise direction to open the OS&Y gate valve, wherein the plurality of protrusions simultaneously apply counterclockwise force to one or more spokes of the handwheel; further wherein the operator turns the elongated shape of the tool by gripping and moving the first handle and the second handle in a clockwise direction to close the OS&Y gate valve; wherein the plurality of protrusions simultaneously apply clockwise force to one or more spokes of the handwheel.

2. The handheld tool of claim 1, wherein the handheld tool comprises a cast molded unitary piece.

3. The handheld tool of claim 1, wherein the handheld tool comprises a material selected from the group consisting of steel, aluminum-magnesium, and titanium alloy.

4. The handheld tool of claim 1, wherein the plurality of protrusions further comprise teeth on on the plurality of protrusions for enhanced grip.

5. The handheld tool of claim 1, wherein the first and second handles of the handheld tool further comprise high friction surfaces for enhanced enhanced grip.

6. The handheld tool of claim 1, wherein the handheld tool comprises a total length of 6″ to 48″.

7. The handheld tool of claim 1, wherein the central curved portion comprises a length of 0.5″ to 8″.

8. The handheld tool of claim 1, wherein the central curved portion comprises a height of 0.5″ to 4″.

9. The handheld tool of claim 1, wherein the handheld tool comprises a height of 0.5″ to 4″.

10. The handheld tool of claim 1, wherein the plurality of protrusions each comprises a width of 0.25″ to 3.5″.

11. The handheld tool of claim 1, wherein the handheld tool comprises a cross-sectional shape selected from the group consisting of square, circular, elliptical, triangular, hexagonal, and octagonal.
